(19) United States
(12) Patent Application Publication
(10) Pub. No.: US 2024/0411804 A1
(43) Pub. Date: Dec. 12, 2024

(54) SYSTEM AND METHOD FOR OPEN-VOCABULARY QUERY-BASED DENSE RETRIEVAL AND MULTI SCALE LOCALIZATION

(71) Applicant: GM GLOBAL TECHNOLOGY OPERATIONS LLC, Detroit, MI (US)

(72) Inventors: Hila Levi, Rechovot (IL); Dan Levi, Ganei Tikvah (IL)

(73) Assignee: GM GLOBAL TECHNOLOGY OPERATIONS LLC, Detroit, MI (US)

(21) Appl. No.: 18/330,537

(22) Filed: Jun. 7, 2023

(51) Int. Cl. G06F 16/55; G06F 16/53; G06F 16/56; G06F 16/587; G06V 10/74; G06V 10/764; G06V 20/56

(52) U.S. Cl. CPC G06F 16/55; G06F 16/53; G06F 16/56; G06F 16/587; G06V 10/761; G06V 10/764; G06V 20/56

(57) ABSTRACT

A method for open-vocabulary query-based dense retrieval is provided. The method includes monitoring camera data including an image related to an object and referencing a set of queries, each of the queries describing a candidate object to be updated by a remote server device. An encoder of an open-vocabulary pre-trained vision-language model system is utilized to initialize a predefined embedding for each query, and a classifier is initialized by mapping the predefined embeddings to weights of the classifier. The method further includes applying a dense open-vocabulary image encoder on the camera data to create a mass of dense embeddings including a set of spatially-arranged embeddings for the image, each including a matrix including embedding vectors. The classifier is utilized by applying the classifier to the plurality of embedding vectors to classify the object within the operating environment as an identified object. The method further includes publishing the identified object.

### BACKGROUND

The present disclosure related to a system and method for open-vocabulary query-based dense retrieval and multi scale localization or multi scale grounding.

An autonomous or semi-autonomous vehicle utilizes a camera device to create data regarding an operating environment of the vehicle. The camera device generates an image of objects, road surfaces, lane markings, and other details of the operating environment. A computerized system of the vehicle analyzes the image to identify or classify details of the operating environment within the image.

A database may be utilized to store information. A computerized system may query a database to retrieve information from the database.

### SUMMARY

A method for open-vocabulary query-based dense retrieval is provided. The method includes, within one or more processors, monitoring camera data from a camera device including at least one image related to an object within an operating environment of a vehicle and referencing a set of queries, each of the set of queries describing a candidate object to be updated by a remote server device. The method further includes utilizing an encoder of an open-vocabulary pre-trained vision-language model system to initialize at least one predefined embedding for each of the set of queries and initializing a classifier by mapping the initialized predefined embeddings to weights of the classifier on the vehicle. The method further includes applying a dense open-vocabulary image encoder on the camera data to create a mass of dense embeddings including a set of spatially-arranged embeddings for the at least one image. Each set of the spatially-arranged embeddings includes an output matrix including a plurality of embedding vectors. The method further includes utilizing the classifier by applying the classifier to the plurality of embedding vectors to generate a probability that the object is an identified, relevant object and, when the probability exceeds a threshold probability value, classifying the object within the operating environment as the identified, relevant object based upon the classifier. The method further includes publishing the identified, relevant object for use in a device in the operating environment.

In some embodiments, applying the dense open-vocabulary image encoder on the camera data includes applying a dense, multi-scale, open-vocabulary image encoder on the camera data including multiple resolutions of the at least one image.

In some embodiments, publishing the identified, relevant object includes applying triggered recording of the camera data, adding the identified, relevant object to an on-the-fly map based upon a location of the camera device or providing an alert through an online application.

In some embodiments, the classifier is a first classifier. The method further includes, after classifying the object as the identified, relevant object, initializing an embedding of the object and mapping the initialized embedding of the object to a second classifier to be used for tracking the identified, relevant object.

In some embodiments, the classifier is a first classifier. The method further includes, after classifying the object as the identified, relevant object, initializing an embedding of the object and mapping the initialized embedding of the object to a second classifier to be used for classifying a refined, identified, relevant object.

In some embodiments, the classifier is a first classifier. The method further includes, after classifying the object as the identified, relevant object, initializing an embedding of the object and mapping the initialized embedding of the object to a second classifier to be used for refining a location of the identified, relevant object.

In some embodiments, the classifier is a first classifier. The method further includes, after classifying the object as the identified, relevant object, initializing an embedding of the object and mapping the initialized embedding of the object to a second classifier to be used for triggering a stop recording event.

According to one alternative embodiment, a method for open-vocabulary query-based dense retrieval is provided. The method includes, within one or more processors, monitoring camera data from a camera device including at least one image related to an object within an operating environment of a vehicle and referencing a set of queries, each of the set of queries describing a candidate object to be updated by a remote server device. The method further includes utilizing an encoder of an open-vocabulary pre-trained vision-language model system to initialize at least one predefined embedding for each of the set of queries and initializing a classifier by mapping the initialized predefined embeddings to weights of the classifier on the vehicle. The method further includes applying a dense, multi-scale, open-vocabulary image encoder on the camera data to create a mass of dense embeddings including a set of spatially-arranged embeddings for the at least one image. Each set of the spatially-arranged embeddings includes an output matrix including a plurality of embedding vectors. The method further includes utilizing the classifier by applying the classifier to the plurality of embedding vectors to generate a probability that the object is an identified, relevant object and, when the probability exceeds a threshold probability value, classifying the object within the operating environment as the identified, relevant object based upon the classifier. The method further includes publishing the identified, relevant object for use in a device in the operating environment. Publishing the identified, relevant object includes applying triggered recording of the camera data, adding the identified, relevant object to an on-the-fly map based upon a location of the camera device or providing an alert through an online application.

In some embodiments, the classifier is a first classifier. The method further includes, after classifying the object as the identified, relevant object, initializing an embedding of the object and mapping the initialized embedding of the object to a second classifier to be used for tracking the identified, relevant object.

In some embodiments, the classifier is a first classifier. The method further includes, after classifying the object as the identified, relevant object, initializing an embedding of the object and mapping the initialized embedding of the object to a second classifier to be used for classifying a refined, identified, relevant object.

According to one alternative embodiment, a method for open-vocabulary query-based dense retrieval is provided. The method includes, within a processor of a remote server device, utilizing a predefined set of queries and utilizing an encoder of an open-vocabulary pre-trained vision-language model system to perform search embedding, initializing a plurality of predefined search embeddings including at least one predefined search embedding for each of the queries of the predefined set of queries. The method further includes, within the processor, referencing an indexed database including a plurality of images. The plurality of images each include a plurality of objects, each of the plurality of objects including object-specific attributes, wherein, within each of the plurality of images, the plurality of objects is spatially arranged in a two-dimensional space. The method further includes, within the processor, applying a dense open-vocabulary image encoder on each of the plurality of images within the indexed database to create an indexed mass of dense embeddings including a set of spatially-arranged embeddings for each of the plurality of images of the indexed database, wherein each set of the spatially-arranged embeddings includes an output matrix including a plurality of embedding vectors. The method further includes, within the processor, utilizing a search engine system to search on the indexed mass of dense embeddings. The search includes ranking each of the plurality of images of the indexed database and a corresponding set of spatially-arranged embeddings to each of the plurality of predefined search embeddings and determining a similarity of each of the plurality of images of the indexed database to the corresponding set of spatially-arranged embeddings. The search further includes selecting a subset of the plurality of images of the indexed database as a plurality of nearest neighbors of each the plurality of predefined search embeddings based upon the ranking and the similarity to each of the plurality of predefined search embedding. The method further includes subsequently processing an online request from a remote device based on the plurality of nearest neighbors to retrieve an output to the online request.

In some embodiments, the method further includes refining and updating the plurality of predefined search embeddings to create a plurality of updated, predefined search embeddings based upon processing the output to the online request.

In some embodiments, refining and updating the plurality of predefined search embeddings includes clustering portions of the indexed mass of dense embeddings to improve and accelerate search results.

In some embodiments, the remote device includes a vehicle. The method further includes mapping the plurality of updated, predefined search embeddings to be used within a classifier on the vehicle.

In some embodiments, the method further includes adding an additional predefined search embedding to the plurality of predefined search embeddings based upon processing the output to the online request.

In some embodiments, the method further includes iteratively refining and updating the plurality of predefined search embeddings based upon processing iterations of the output to the online request.

In some embodiments, processing the online request includes utilizing camera data including at least one image related to an object within an operating environment of the remote device and applying the dense open-vocabulary image encoder on the camera data to create a second mass of dense embeddings including a second set of spatially-arranged embeddings for the at least one image, wherein each of the second set of spatially-arranged embeddings includes a second output matrix including a second plurality of embedding vectors. Retrieving the output to the online request includes comparing the second set of spatially-arranged embeddings for the at least one image to the plurality of predefined search embeddings to identify the object as an identified, relevant object.

In some embodiments, the method further includes utilizing iterations of the camera data and iterations of the set of spatially-arranged embeddings to visualize the object.

In some embodiments, the method further includes applying rules to identify validated object instances based upon the at least one image including a first query of the set of predefined queries corresponding to the identified, relevant object in a position corresponding to the set of spatially-arranged embeddings. The rules includes user validation, semi-automatically applied rules, or automatically applied rules.

In some embodiments, the method further includes utilizing the validated object instances to annotate and enrich the indexed database.

The above features and advantages and other features and advantages of the present disclosure are readily apparent from the following detailed description of the best modes for carrying out the disclosure when taken in connection with the accompanying drawings.

### BRIEF DESCRIPTION OF DRAWINGS

FIG. 1 schematically illustrates an exemplary device including a camera device and an image analysis controller, in accordance with the present disclosure;

FIG. 2 schematically illustrates the image analysis controller of FIG. 1, in accordance with the present disclosure;

FIG. 3 schematically illustrates the remote server device of FIG. 1, in accordance with the present disclosure;

FIG. 4 schematically illustrates an image being analyzed according to a patch-based image analysis, in accordance with the present disclosure;

FIG. 5 schematically illustrates an image patch being compared with images retrieved through an open-vocabulary query based dense retrieval process, wherein reference images are images retrieved from an image database for comparison to data contained within the image patch, in accordance with the present disclosure;

FIG. 6 is a flowchart illustrating a method for open-vocabulary query-based dense retrieval and multi scale localization, in accordance with the present disclosure; and

FIG. 7 is a flowchart illustrating a method for training a remote server device including an indexed database including a plurality of images and an indexed mass of dense embeddings including a set of spatially-arranged embeddings for each of the plurality of images of the indexed database, in accordance with the present disclosure.

### DETAILED DESCRIPTION

A system and method for image analysis including open-vocabulary retrieval at an object level is provided. The system and method allow the search and the localization of arbitrary concepts in large databases or streams of images.

The disclosed system and method may include a computerized method and/or hardware configured to train an offline or remote server device to include an indexed database including a plurality of images. Each of the images may include a plurality of objects spatially arranged in a two-dimensional space. The method to train the device to include the indexed database may additionally include applying an open-vocabulary image encoder on each of the plurality of images to create an indexed mass of dense embeddings including a set of spatially-arranged embeddings for each of the plurality of images of the indexed database. Each set of the spatially-arranged embeddings includes an output matrix including a plurality of embedding vectors. The method to train the device may further include utilizing a predefined set of queries. The method to train the device may further include utilizing an encoder of an open-vocabulary pre-trained vision-language model system to perform search embedding. Performing the search embedding includes initializing a plurality of predefined search embeddings including at least one predefined search embedding for each of the queries of the predefined set of queries. The method to train the device may further include utilizing a search engine system to search on the indexed mass of dense embeddings. This search includes ranking each of the plurality of images of the indexed database and a corresponding set of spatially-arranged embeddings to each of the plurality of predefined search embeddings. The search further includes determining a similarity of each of the plurality of images of the indexed database to the corresponding set of spatially-arranged embeddings. The search further includes selecting a subset of the plurality of images of the indexed database as a plurality of nearest neighbors of each of the plurality of predefined search embeddings based upon the ranking and the similarity to each of the plurality of predefined search embeddings. Once the offline or remote server device is trained, the trained device may be utilized to process an online request from a remote device based on the plurality of nearest neighbors to retrieve an output to the online request.

Training the offline or remote server device may include refining and updating the plurality of predefined search embeddings to create a plurality of updated, predefined search embeddings based upon processing the output to the online request. Refining and updating the plurality of predefined search embeddings may include clustering portions of the indexed mass of dense embeddings to improve and accelerate search results.

The remote device initiating the online request may include a vehicle. The trained device may be utilized to map the plurality of updated, predefined search embeddings to be used within a classifier on the vehicle.

The remote device may add an additional predefined search embedding to the plurality of predefined search embeddings based upon processing the output to the online request.

The remote device may iteratively refine and update the plurality of predefined search embeddings based upon processing iterations of the output to the online request.

The disclosed system and method may include a computerized method and/or hardware configured to utilize a trained offline or remote sever device to identify an object within an image. The system and method to utilize the trained device may include monitoring camera data including at least one image related to an object within an operating environment of a vehicle and referencing a set of queries. Each of the queries describing a candidate object to be updated by the remote server device. The system and method to utilize the trained device may further include utilizing an encoder of an open-vocabulary pre-trained vision-language model system to initialize at least one predefined embedding for each of the queries of the set of queries and initializing a classifier by mapping the initialized predefined embeddings to weights of the classifier on the vehicle. The system and method to utilize the trained device may further include applying a dense, multi-scale, open-vocabulary image encoder on the camera data to create a mass of dense embeddings including a set of spatially-arranged embeddings for the at least one image. Each set of the spatially-arranged embeddings includes an output matrix including a plurality of embedding vectors. The system and method to utilize the trained device may further include utilizing the classifier by applying the classifier to the embedding vectors to generate a probability that the object is an identified, relevant object and, when the probability exceeds a threshold probability value, classifying the object within the operating environment as the identified, relevant object based upon the classifier. The system and method to utilize the trained device may further include publishing the identified, relevant object for use in a device in the operating environment. Publishing the identified, relevant object includes applying triggered recording of the camera data, adding the identified, relevant object to an on-the-fly map based upon a location of the camera device or providing an alert through an online application.

Publishing the identified, relevant object may include applying triggered recording of the camera data, adding the identified, relevant object to an on-the-fly map based upon a location of the camera device or providing an alert through an online application.

In some instances, when utilizing the trained device, the classifier may be a first classifier, and the method to utilize the trained device may further include, after classifying the object as the identified, relevant object, initializing an embedding of the object and mapping the initialized embedding of the object to a second classifier to be used for tracking the identified, relevant object.

In some instances, when utilizing the trained device, the classifier may be a first classifier, and the method to utilize the trained device may further include, after classifying the object as the identified, relevant object, initializing an embedding of the object and mapping the initialized embedding of the object to a second classifier to be used for classifying a refined, identified, relevant object.

In some instances, when utilizing the trained device, the classifier may be a first classifier, and the method to utilize the trained device may further include, after classifying the object as the identified, relevant object, initializing an embedding of the object and mapping the initialized embedding of the object to a second classifier to be used for refining a location of the identified, relevant object.

In some instances, when utilizing the trained device, the classifier may be a first classifier, and the method to utilize the trained device may further include, after classifying the object as the identified, relevant object, initializing an embedding of the object and mapping the initialized embedding of the object to a second classifier to be used for triggering a stop recording event.

In utilizing the trained offline or remote server device, one or more images from a device such as a vehicle may be analyzed or put through image analysis to identify an object of interest to be classified. The image analysis may include patch-based image analysis or patch-based classification. An image including a complex scene may be segmented, and one of the segments may be analyzed as a patch. Identifiable properties in the patch may allow the patch to be classified. A patch may be classified as including a road surface, a vehicle, a pedestrian, etc. An image may include a plurality of patches with significant amounts of information or may be a complex image dataset. This step may be described as selecting a portion of an image representing a complex scene as including an object that is to be identified.

Utilizing the trained offline or remote server device may additionally include analyzing the previously classified patch or patches with open-vocabulary retrieval at the object level. For example, a patch may be initially classified as including a pedestrian. This classification may provide a low or moderate certainty that a pedestrian is represented in that patch or portion of the image being analyzed. However, images of real-life occurrences may be less than ideal. The person may be partially obscured by a telephone pole or may be wearing an exotic costume. Images of exemplary pedestrians for comparison to information in the patch being analyzed may be stored in a database locally within the vehicle. Images of exemplary pedestrians for comparison to information in the patch being analyzed may be stored in the trained device including an indexed database that may be accessed over a wireless communication network. Comparisons between stored images and information in the patch being analyzed may increase or decrease a certainty of the initial classification, enabling the system and method to generate an updated classification of the patch with improved certainty.

A system and method for open-vocabulary query-based dense retrieval and multi scale localization is provided. The disclosed system is capable of efficiently performing an open vocabulary query in complex images by combining existing elements in a novel way. Elements of the system include, one, a learned visual language model (e.g., Contrastive Language-Image Pre-Training (CLIP), Align, Florence), tailored to supply spatially dense embedding and, two, a retrieval system or multi-scale coarse segmentation framework over the dense features. Combining these two sub-systems in a multi-scale manner allows rapid searches at the object-level and opens the door for several pre or post spatial-processing procedures, each with its own online or offline applicable advantages.

Additional procedures useful with the disclosed system and method include but are not limited to efficiently representing the dense image features in the database, re-ranking images based on a spatial post processing step over the already kept features, interpretable visualization by the resulting coarse segmentation maps, using the coarse masks as pseudo label for optimizing (the same or another) network, inputs or prompts in multi-iterations operating mode, and using the coarse mask as an initial guess for further human-in-the-loop annotations.

The disclosed system and method combine a learned visual language model, tailored to supply spatially dense embedding and a retrieval & localization system to search over the dense features. The disclosed combination enables several spatial-based processes, aimed to increase accuracy and interpretability. The disclosed system and method may include use of dense CLIP to perform an open-vocabulary long-tailed localization and multi-scale segmentation on vehicle data.

The disclosed system and method may enable online implementation examples. A triggered record may be utilized to automatically record clips with detected pre-defined concepts. The disclosed system and method may be utilized to create an on-the-fly map of localized pre-defined objects for smart-city or other recognition-based applications.

The disclosed system and method may be utilized with offline processes or software applications. The system may search and annotate relevant concepts to be used as pseudo labels for further use with or without a human in the loop.

Objects within an image patch may be identified and/or classified. This process of identifying objects and their locations in an operating environment, determining likely rules and behavior for the objects, and evaluating a likelihood of particular outcomes in relation to the objects may be described as localizing the objects or grounding the objects such that navigational commands may be generated in light of the localized or grounded objects.

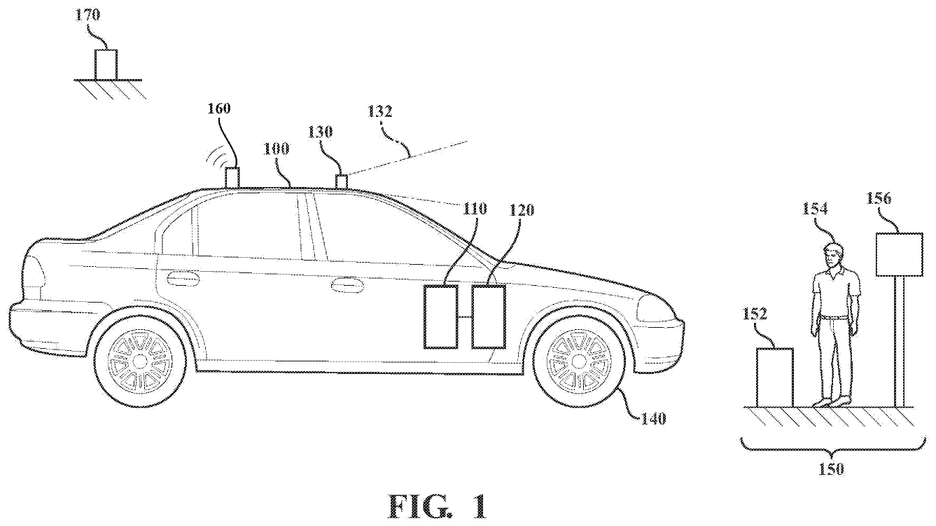

FIG. 1 schematically illustrates an exemplary device 100 including a camera device and an image analysis controller 110. The device 100 is illustrated as an exemplary vehicle. Other embodiments of device 100 may include a boat, a piece of construction equipment, an airplane, or other devices that may utilize images to interpret features within a local operating environment. The device 100 is illustrated including the image analysis controller 110, an output device 120, a camera device 130, wheels 140, and a communications device 160. The camera device 130 provides at least one image of viewpoint 132. The image includes a matrix of pixels that describe details about objects in an operating environment 150 of the device 100. Exemplary objects in the operating environment 150 are provided including a nondescript object 152, a pedestrian 154, and a road sign 156. The image generated by the camera device 130 of viewpoint 132 includes a two-dimensional matrix of pixels that represent at least one of the nondescript object 152, the pedestrian 154, and the road sign 156.

The image analysis controller 110 is a computerized device executing programming to operate the disclosed method for open-vocabulary query-based dense retrieval and multi scale localization. The image analysis controller 110 receives the image from the camera device 130 and performs steps of the disclosed method. The image analysis controller 110 provides an output to the output device 120 which includes perceived details about the operating environment 150 useful to a user of the device 100. Examples of useful outputs includes warnings, alerts, updated map details, and informational displays.

The communications device 160 is illustrated communicating with remote resources over a wireless communications network. A remote server device 170 is provided as an exemplary remote resource with which the communications device 160 may communicate. The remote server device 170 may, in one embodiment, include an indexed database of reference images which may be utilized to compare to portions of the image generated by the camera device 130 and classify the data in those portions. The remote server device 170, in another embodiment, may be utilized to train reference images in a database within the device 100, for example, such as a database stored within the image analysis controller 110.

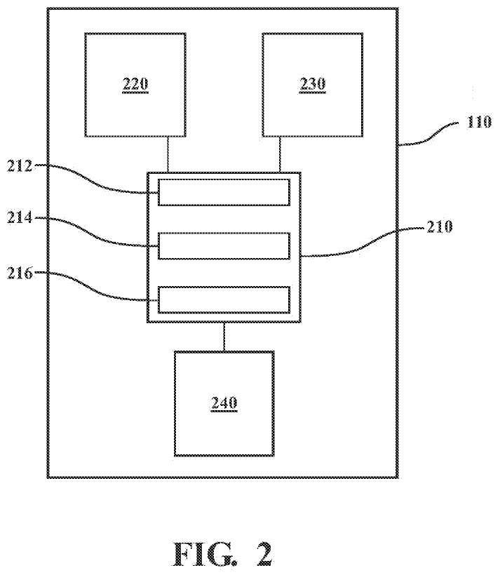

FIG. 2 schematically illustrates the image analysis controller 110. The image analysis controller 110 includes a computerized processing device 210, a communications device 220, an input output coordination device 230, and a memory storage device 240. It is noted that the image analysis controller 110 may include other components and some of the components are not present in some embodiments.

The processing device 210 may include memory, e.g., read only memory (ROM) and random-access memory (RAM), storing processor-executable instructions and one or more processors that execute the processor-executable instructions. In embodiments where the processing device 210 includes two or more processors, the processors may operate in a parallel or distributed manner. The processing device 210 may execute the operating system of the image analysis controller 110. Processing device 210 may include one or more modules executing programmed code or computerized processes or methods including executable steps. Illustrated modules may include a single physical device or functionality spanning multiple physical devices. The processing device 210 may further include programming modules, including a patch-based analysis module 212, a database interaction module 214, and an output module 216. In one embodiment, the image analysis controller 110 or portions thereof may include electronic versions of the processing device.

The communications device 220 may include a communications/data connection with a bus device configured to transfer data to different components of the system and may include one or more wireless transceivers for performing wireless communication.

The input output coordination device 230 includes hardware and/or software configured to enable the processing device 210 to receive and/or exchange data with on-board sensors of the host vehicle and to provide control of switches, modules, and processes throughout the vehicle based upon determinations made within processing device 210.

The memory storage device 240 is a device that stores data generated or received by the image analysis controller 110. The memory storage device 240 may include, but is not limited to, a hard disc drive, an optical disc drive, and/or a flash memory drive.

The patch-based analysis module 212 includes programming to receive an image from the camera device 130 of FIG. 1. The patch-based analysis module 212 further includes programming to identify a portion of the image as a patch including significant or potentially interesting information. The patch-based analysis module 212 further includes programming to provide an initial classification of the information within the patch. The initial classification may label the patch as including information about a road marking, including an image of a vehicle or a pedestrian, or including data that cannot be classified as part of the patch-based analysis. The patch-based analysis module 212 may include programming to track objects or features and/or compare patches between or from a first image to a second image, for example, through a sequence of images taken through a time period.

The database interaction module 214 includes programming to evaluate data within a patch identified by the patch-based analysis module 212. In one embodiment, the database interaction module 214 may transform data regarding an image or a patch from the patch-based analysis module 212 and use this data to create an online request for use by the remote server device 170 of FIG. 1. This online request may include image or other data useful for the remote server device 170 to determine whether the object is an identified, relevant object. This output, the determination of the object as an identified, relevant object, is provided by the remote server device 170 to the database interaction module 214. Optionally, the database interaction module 214 may include an on-board classifier to determine an on-board classification.

The output module 216 includes programming to provide data to the output device 120 of FIG. 1. The output module 216 may provide an output directing an audible or visual alert, providing data for a map or other visual display, or other similar output to a user.

The image analysis controller 110 is provided as an exemplary computerized device capable of executing programmed code to operate the disclosed process. A number of different embodiments of the image analysis controller 110 and modules operable therein are envisioned, and the disclosure is not intended to be limited to examples provided herein.

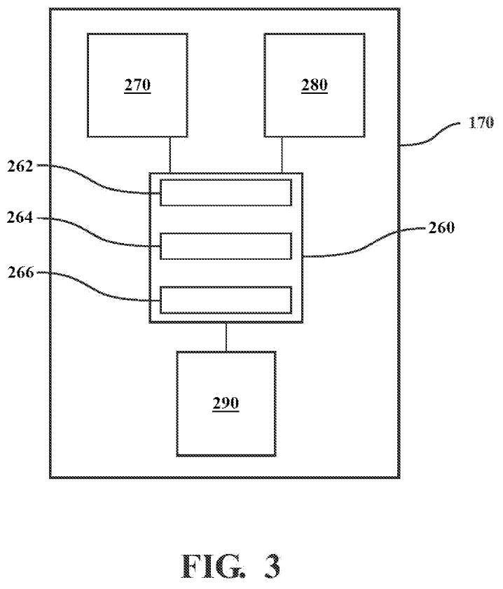

FIG. 3 schematically illustrates the remote server device 170. The remote server device 170 includes a computerized processing device 260, a communications device 270, an input output coordination device 280, and a memory storage device 290. It is noted that the remote server device 170 may include other components and some of the components are not present in some embodiments.

The processing device 260 may include memory, e.g., ROM and RAM, storing processor-executable instructions and one or more processors that execute the processor-executable instructions. In embodiments where the processing device 260 includes two or more processors, the processors may operate in a parallel or distributed manner. The processing device 260 may execute the operating system of the remote server device 170. Processing device 260 may include one or more modules executing programmed code or computerized processes or methods including executable steps. Illustrated modules may include a single physical device or functionality spanning multiple physical devices. The processing device 260 may further include programming modules, including a training module 262, an online request processing module 264, and an output module 266. In one embodiment, the remote server device 170 or portions thereof may include electronic versions of the processing device.

The communications device 270 may include a communications/data connection with a bus device configured to transfer data to different components of the system and may include one or more wireless transceivers for performing wireless communication.

The input output coordination device 280 includes hardware and/or software configured to enable the processing device 260 to receive and/or exchange data with on-board sensors of the host vehicle and to provide control of switches, modules, and processes throughout the vehicle based upon determinations made within processing device 260.

The memory storage device 290 is a device that stores data generated or received by the remote server device 170. The memory storage device 290 may include, but is not limited to, a hard disc drive, an optical disc drive, and/or a flash memory drive. The memory storage device 290 may include an indexed database including a plurality of images and may include or be trained with an indexed mass of dense embeddings including a set of spatially-arranged embeddings for each of the plurality of images of the indexed database, in accordance with the methods disclosed herein.

The training module 262 includes programming to train the remote server device 170 with the indexed database including the plurality of images and the indexed mass of dense embeddings including a set of spatially-arranged embeddings for each of the plurality of images. A training method employed by the training module 262 may include steps to initialize a plurality of predefined search embeddings corresponding to a predefined set of queries, reference an indexed database including a plurality of images, apply an open-vocabulary image encoder on each of the plurality of images to create an indexed mass of dense embeddings including a set of spatially-arranged embeddings for each of the plurality of images, and utilize a search engine system to search on the indexed mass of dense embeddings. The search may include ranking and determining similarity of each of the plurality of images in the database to a corresponding set of spatially-arranged embeddings to the plurality of predefined search embeddings. The search may additionally include selecting a subset of the plurality of images of the indexed database as a plurality of nearest neighbors of each the plurality of predefined search embeddings as a result of the search. This process may be iterative, for example, refining and updating the plurality of predefined search embeddings to create a plurality of updated, predefined search embeddings. The subset of the plurality of images of the indexed database as a plurality of nearest neighbors is useful to process online requests and classify objects in camera data.

The online request processing module 264 includes programming to receive data from a remote device such as device 100 of FIG. 1. The online request processing module 264 further includes programming to classify or determine a probability that an object in the data from the remote device is an identified, relevant object to be reported.

The output module 266 includes programming to receive and process information from the online request processing module 264 and report it to the image analysis controller 110 of FIG. 1.

The remote server device 170 is provided as an exemplary computerized device capable of executing programmed code to operate the disclosed process. A number of different embodiments of the remote server device 170 and modules operable therein are envisioned, and the disclosure is not intended to be limited to examples provided herein.

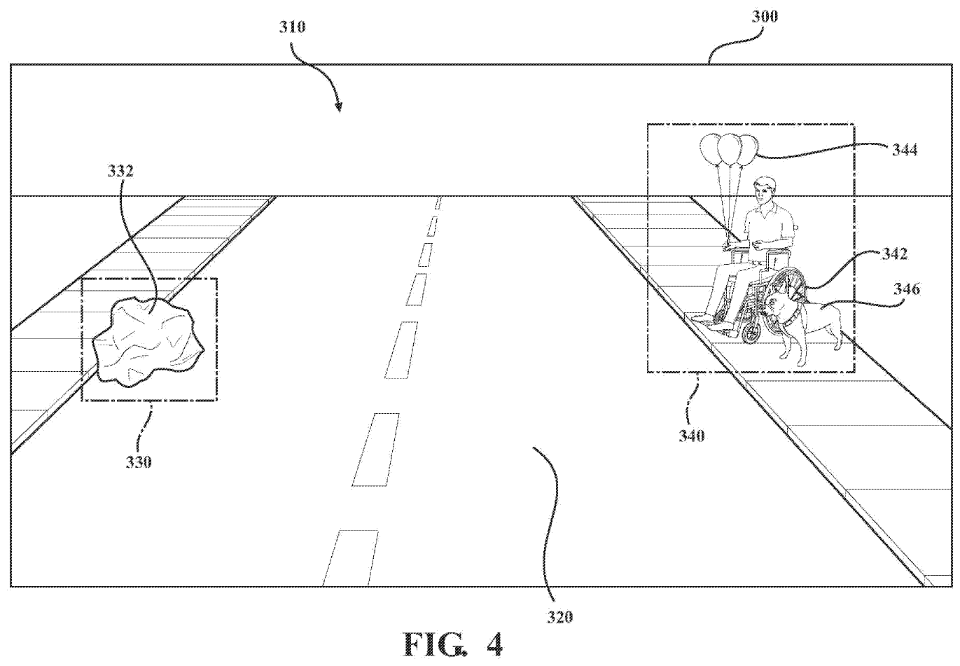

FIG. 4 schematically illustrates an image 300 being analyzed according to a patch-based image analysis. The image 300 includes a matrix of pixels 310 which include data regarding the operating environment 150 of the device 100 of FIG. 1. The matrix of pixels 310 includes pixels representing a road surface 320. A first portion of the pixels of the matrix of pixels 310 represent an object 332. The object 332 is illustrated as an irregular object defying a clear classification. A second portion of the pixels of the matrix of pixels 310 represent a person in a wheelchair 342, a bunch of helium balloons 344, and a dog 346. A patch-based analysis such as may be operated by the patch-based analysis module 212 of FIG. 2 may identify or define a first patch 330 including the first portion of pixels representing the object 332. Further, a second patch 340 may be defined including the second portion of pixels representing the person in the wheelchair 342, the bunch of helium balloons 344, and the dog 346. The patch-based analysis may identify or classify objects within the patches. For example, the patch 340 may clearly include pixels representing a person which may be identified based upon simple image recognition of a face. However, more details regarding the objects within patch 340 may be desirable, for example, to characterize likely movement or behavior of the objects within the patch 340.

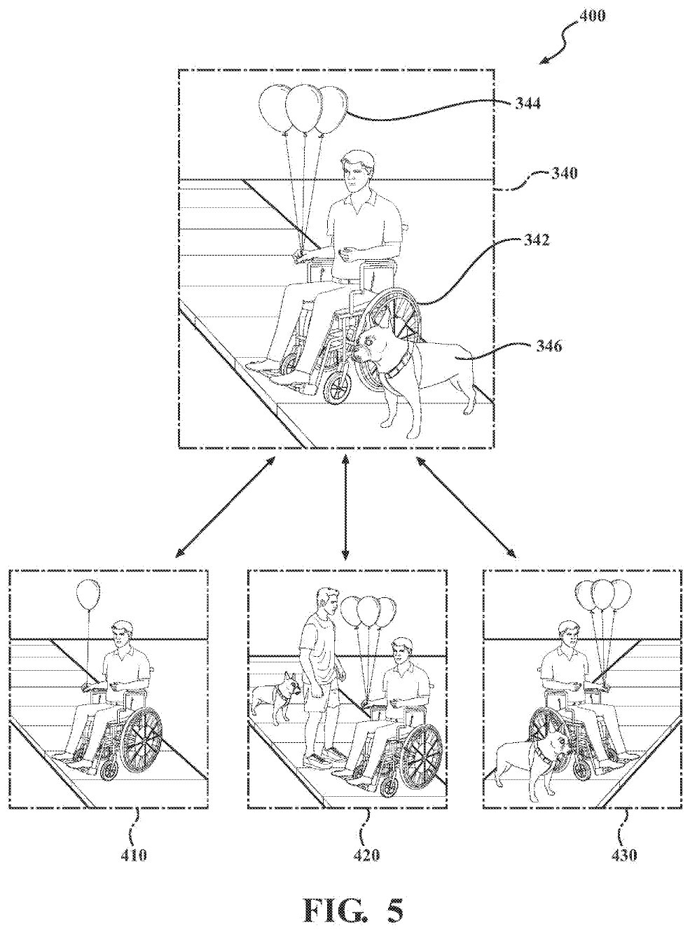

FIG. 5 schematically illustrates a comparison 400 of the image patch 340 of FIG. 4 with reference images 410, 420, 430. The reference images 410, 420, 430 are retrieved through an open-vocabulary query based dense retrieval process for comparison to data contained within the image patch 340. The image patch 340 is illustrated including the person in the wheelchair 342, the bunch of helium balloons 344, and the dog 346. An image encoder and/or a text encoder may be utilized to develop one or more open-vocabulary terms to describe objects represented by the pixels of the image patch 340. The open-vocabulary terms may be utilized to query and retrieve reference images 410, 420, 430 for comparison to the data within the image patch 340. The reference images 410, 420, 430 may be stored in a database, either at a remote location or in a database stored locally within the device 100 of FIG. 1. The reference images 410, 420, 430 may be linked or paired with information, such as behavior traits and tendencies of the objects in the images. As the comparison 400 is performed, a classification of objects within the image patch 340 may be determined.

The comparison 400 may additionally or alternatively be performed upon the patch 330 of the object 332 of FIG. 4. The object 332 may include refuse, for example, a bag full of litter discarded upon the road surface 320. The database interaction module 214 of FIG. 2 in combination with the remote server device of FIG. 3 may analyze the object 332, may develop an open-vocabulary term for a bag filled with litter, and may classify the object 332 according to likely behavior for such an object.

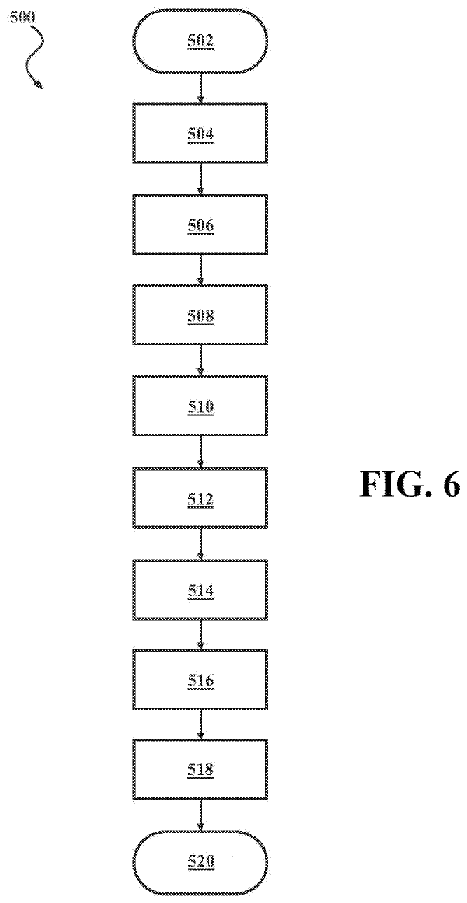

FIG. 6 is a flowchart illustrating a method 500 for open-vocabulary query-based dense retrieval and multi scale localization. The method 500 may be utilized within one or more processors of the device 100 of FIG. 1 equipped with the image analysis controller 110 and within one or more processors of the remote server device 170 of FIG. 1. The method 500 begins at step 502. At step 504, an additional method step includes monitoring camera data from a camera device including at least one image related to an object within an operating environment of a vehicle. At step 506, an additional method step includes referencing a set of queries, each of the set of queries describing a candidate object to be updated by a remote server device. At step 508, an additional method step includes utilizing an encoder of an open-vocabulary pre-trained vision-language model system to initialize at least one predefined embedding for each of the set of queries. At step 510, an additional method step includes initializing a classifier by mapping the initialized predefined embeddings to weights of the classifier on the vehicle. At step 512, an additional method step includes applying a dense, multi-scale, open-vocabulary image encoder on the camera data to create a mass of dense embeddings including a set of spatially-arranged embeddings for the at least one image. Each set of the spatially-arranged embeddings includes an output matrix including a plurality of embedding vectors. At step 514, an additional method step includes utilizing the classifier by applying the classifier to the plurality of embedding vectors to generate a probability that the object is an identified, relevant object. At step 516, when the probability exceeds a threshold probability value, an additional method step includes classifying the object within the operating environment as the identified, relevant object based upon the classifier. At step 518, an additional method step includes publishing the identified, relevant object for use in a device in the operating environment. Publishing the identified, relevant object includes applying triggered recording of the camera data, adding the identified, relevant object to an on-the-fly map based upon a location of the camera device or providing an alert through an online application. At step 520, the method 500 ends. The method 500 is an exemplary method for open-vocabulary query-based dense retrieval and multi scale localization or multi scale grounding. Other methods and additional or alternative method steps are envisioned, and the disclosure is not intended to be limited to the examples provided herein.

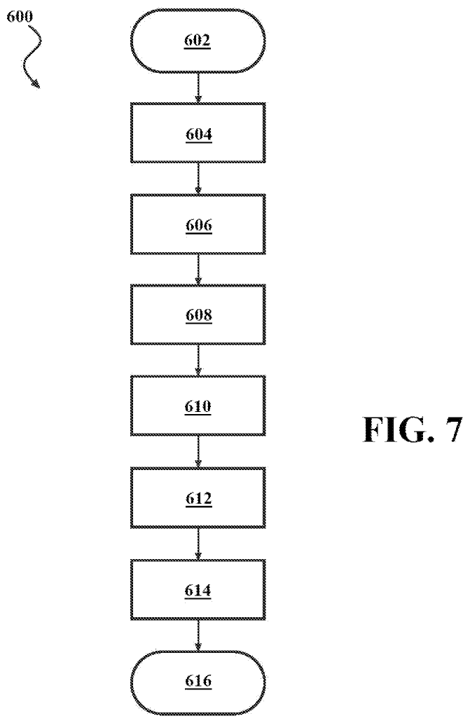

FIG. 7 is a flowchart illustrating a method 600 for training the remote server device 170 of FIG. 1. The method 600 may be operated within a processor of the remote server device 170. The method 600 begins at step 602. At step 604, an additional method step includes utilizing a predefined set of queries. At step 606, an additional method step includes utilizing an encoder of an open-vocabulary pre-trained vision-language model system to perform search embedding, initializing a plurality of predefined search embeddings including at least one predefined search embedding for each of the queries of the predefined set of queries. At step 608, an additional method step includes referencing an indexed database including a plurality of images, wherein the plurality of images each include a plurality of objects, each of the plurality of objects including object-specific attributes. Within each of the plurality of images, the plurality of objects is spatially arranged in a two-dimensional space. At step 610, an additional method step includes applying a dense open-vocabulary image encoder on each of the plurality of images within the indexed database to create an indexed mass of dense embeddings including a set of spatially-arranged embeddings for each of the plurality of images of the indexed database. Each set of the spatially-arranged embeddings includes an output matrix including a plurality of embedding vectors. At step 612, an additional method step includes utilizing a search engine system to search on the indexed mass of dense embeddings. The search of step 612 includes ranking each of the plurality of images of the indexed database and a corresponding set of spatially-arranged embeddings to each of the plurality of predefined search embeddings. The search of step 612 further includes determining a similarity of each of the plurality of images of the indexed database to the corresponding set of spatially-arranged embeddings. The search of step 612 further includes selecting a subset of the plurality of images of the indexed database as a plurality of nearest neighbors of each the plurality of predefined search embeddings based upon the ranking and the similarity to each of the plurality of predefined search embeddings. At step 614, an additional method step includes subsequently processing an online request from a remote device based on the plurality of nearest neighbors to retrieve an output to the online request. At step 616, the method 600 ends. The method 600 is an exemplary method to train the remote server device 170 of FIG. 1. Other methods and additional or alternative method steps are envisioned, and the disclosure is not intended to be limited to the examples provided herein.

While the best modes for carrying out the disclosure have been described in detail, those familiar with the art to which this disclosure relates will recognize various alternative designs and embodiments for practicing the disclosure within the scope of the appended claims.

What is claimed is:

1. A method for open-vocabulary query-based dense retrieval, comprising:
within one or more processors:
monitoring camera data from a camera device including at least one image related to an object within an operating environment of a vehicle;
referencing a set of queries, each of the set of queries describing a candidate object to be updated by a remote server device;
utilizing an encoder of an open-vocabulary pre-trained vision-language model system to initialize at least one predefined embedding for each of the set of queries;
initializing a classifier by mapping the initialized predefined embeddings to weights of the classifier on the vehicle;
applying a dense open-vocabulary image encoder on the camera data to create a mass of dense embeddings including a set of spatially-arranged embeddings for the at least one image, wherein each set of the spatially-arranged embeddings includes an output matrix including a plurality of embedding vectors;
utilizing the classifier by applying the classifier to the plurality of embedding vectors to generate a probability that the object is an identified, relevant object;
when the probability exceeds a threshold probability value, classifying the object within the operating environment as the identified, relevant object based upon the classifier; and
publishing the identified, relevant object for use in a device in the operating environment.

2. The method of claim 1, wherein applying the dense open-vocabulary image encoder on the camera data includes applying a dense, multi-scale, open-vocabulary image encoder on the camera data including multiple resolutions of the at least one image.

3. The method of claim 1, wherein publishing the identified, relevant object includes applying triggered recording of the camera data, adding the identified, relevant object to an on-the-fly map based upon a location of the camera device or providing an alert through an online application.

4. The method of claim 1, wherein the classifier is a first classifier; and
further comprising:
after classifying the object as the identified, relevant object, initializing an embedding of the object; and
mapping the initialized embedding of the object to a second classifier to be used for tracking the identified, relevant object.

5. The method of claim 1, wherein the classifier is a first classifier; and
further comprising:
after classifying the object as the identified, relevant object, initializing an embedding of the object; and
mapping the initialized embedding of the object to a second classifier to be used for classifying a refined, identified, relevant object.

6. The method of claim 1, wherein the classifier is a first classifier; and
further comprising:
after classifying the object as the identified, relevant object, initializing an embedding of the object; and
mapping the initialized embedding of the object to a second classifier to be used for refining a location of the identified, relevant object.

7. The method of claim 1, wherein the classifier is a first classifier; and
further comprising:
after classifying the object as the identified, relevant object, initializing an embedding of the object; and
mapping the initialized embedding of the object to a second classifier to be used for triggering a stop recording event.

8. A method for open-vocabulary query-based dense retrieval, comprising:
within one or more processors:
monitoring camera data from a camera device including at least one image related to an object within an operating environment of a vehicle;
referencing a set of queries, each of the set of queries describing a candidate object to be updated by a remote server device;
utilizing an encoder of an open-vocabulary pre-trained vision-language model system to initialize at least one predefined embedding for each of the set of queries;
initializing a classifier by mapping the initialized predefined embeddings to weights of the classifier on the vehicle;
applying a dense, multi-scale, open-vocabulary image encoder on the camera data to create a mass of dense embeddings including a set of spatially-arranged embeddings for the at least one image, wherein each set of the spatially-arranged embeddings includes an output matrix including a plurality of embedding vectors;
utilizing the classifier by applying the classifier to the plurality of embedding vectors to generate a probability that the object is an identified, relevant object;
when the probability exceeds a threshold probability value, classifying the object within the operating environment as the identified, relevant object based upon the classifier; and
publishing the identified, relevant object for use in a device in the operating environment, wherein publishing the identified, relevant object includes applying triggered recording of the camera data, adding the identified, relevant object to an on-the-fly map based upon a location of the camera device or providing an alert through an online application.

9. The method of claim 8, wherein the classifier is a first classifier; and
the method further includes:
after classifying the object as the identified, relevant object, initializing an embedding of the object; and
mapping the initialized embedding of the object to a second classifier to be used for tracking the identified, relevant object.

10. The method of claim 8, wherein the classifier is a first classifier; and
the method further includes:
after classifying the object as the identified, relevant object, initializing an embedding of the object; and
mapping the initialized embedding of the object to a second classifier to be used for classifying a refined, identified, relevant object.

11. A method for open-vocabulary query-based dense retrieval, comprising:
within a processor of a remote server device:
utilizing a predefined set of queries;
utilizing an encoder of an open-vocabulary pre-trained vision-language model system to perform search embedding, initializing a plurality of predefined search embeddings including at least one predefined search embedding for each of the queries of the predefined set of queries;
referencing an indexed database including a plurality of images, wherein the plurality of images each include a plurality of objects, each of the plurality of objects including object-specific attributes, wherein, within each of the plurality of images, the plurality of objects is spatially arranged in a two-dimensional space;
applying a dense open-vocabulary image encoder on each of the plurality of images within the indexed database to create an indexed mass of dense embeddings including a set of spatially-arranged embeddings for each of the plurality of images of the indexed database, wherein each set of the spatially-arranged embeddings includes an output matrix including a plurality of embedding vectors;
utilizing a search engine system to search on the indexed mass of dense embeddings, wherein the search includes:
ranking each of the plurality of images of the indexed database and a corresponding set of spatially-arranged embeddings to each of the plurality of predefined search embeddings;
determining a similarity of each of the plurality of images of the indexed database to the corresponding set of spatially-arranged embeddings; and
selecting a subset of the plurality of images of the indexed database as a plurality of nearest neighbors of each the plurality of predefined search embeddings based upon the ranking and the similarity to each of the plurality of predefined search embeddings; and
subsequently processing an online request from a remote device based on the plurality of nearest neighbors to retrieve an output to the online request.

12. The method of claim 11, further comprising refining and updating the plurality of predefined search embeddings to create a plurality of updated, predefined search embeddings based upon processing the output to the online request.

13. The method of claim 12, wherein refining and updating the plurality of predefined search embeddings includes clustering portions of the indexed mass of dense embeddings to improve and accelerate search results.

14. The method of claim 12, wherein the remote device includes a vehicle; and
further comprising mapping the plurality of updated, predefined search embeddings to be used within a classifier on the vehicle.

15. The method of claim 11, further comprising adding an additional predefined search embedding to the plurality of predefined search embeddings based upon processing the output to the online request.

16. The method of claim 11, further comprising iteratively refining and updating the plurality of predefined search embeddings based upon processing iterations of the output to the online request.

17. The method of claim 11, wherein processing the online request includes:
utilizing camera data including at least one image related to an object within an operating environment of the remote device; and
applying the dense open-vocabulary image encoder on the camera data to create a second mass of dense embeddings including a second set of spatially-arranged embeddings for the at least one image, wherein each of the second set of spatially-arranged embeddings includes a second output matrix including a second plurality of embedding vectors; and
wherein retrieving the output to the online request includes comparing the second set of spatially-arranged embeddings for the at least one image to the plurality of predefined search embeddings to identify the object as an identified, relevant object.

18. The method of claim 17, further comprising utilizing iterations of the camera data and iterations of the set of spatially-arranged embeddings to visualize the object.

19. The method of claim 17, further comprising applying rules to identify validated object instances based upon the at least one image including a first query of the set of predefined queries corresponding to the identified, relevant object in a position corresponding to the set of spatially-arranged embeddings, wherein the rules include user validation, semi-automatically applied rules, or automatically applied rules.

20. The method of claim 19, further comprising utilizing the validated object instances to annotate and enrich the indexed database.
